(19) United States
(12) Patent Application Publication
(10) Pub. No.: US 2014/0079965 A1
(43) Pub. Date: Mar. 20, 2014

(54) CONSTRUCTION COMPONENT OF AN ELECTROCHEMICAL CALL AND METHOD FOR PRODUCING SAME

(71) Applicant: Tim Schaefer, Harztor (DE)

(72) Inventor: Tim Schaefer, Harztor (DE)

(73) Assignee: Li-Tec Battery GmbH, Kamenz (DE)

(21) Appl. No.: 14/007,717

(22) PCT Filed: Mar. 21, 2012
(86) PCT No.: PCT/EP2012/001237

§ 371 Date: Nov. 27, 2013

(30) Foreign Application Priority Data
Mar. 28, 2011 (DE) 10 2011 015 285.7

(51) Int. Cl. H01M 2/02; H01M 10/42

(52) U.S. Cl. CPC H01M 2/024; H01M 10/4235
USPC 429/61; 429/163; 429/149; 29/623.1

(57) ABSTRACT

The invention relates to a method for producing a construction component for a vehicle having a composite structure, in particular a hollow cell structure, wherein the composite structure comprises at least one receptacle. The method comprises the step of weaving an electrochemical cell, in particular a flat electrochemical cell, into the at least one receptacle of the construction component or the step of weaving a number of electrochemical cells, in particular a number of flat electrochemical cells, into the least one receptacle of the construction component. Weaving in a number of electrochemical cells can be carried out in such a manner that the number of the electrochemical cells in the at least one receptacle of the construction component forms an electrically connected arrangement, which forms a power supply unit in an electrical and/or electronic and/or control sense.

The invention relates to a method of producing a construction component for a vehicle having a composite structure, a construction component for a vehicle having a composite structure, and a vehicle with a corresponding structural component.

Electrochemical energy stores, also referred to in the following as electrochemical or galvanic cells, are often manufactured in the form of flat, stackable units from which batteries for various applications can be made by combining a plurality of such cells. Particularly in the case of vehicles with electric drives or electric auxiliary drives, it is advantageous to provide reasonable, unobtrusive accommodation for the batteries or accumulators, some of which are quite large.

The entire content of Priority Application DE 10 2011 015 285 is herewith incorporated in the present application by reference.

The underlying object of the present invention is therefore to avoid or overcome the disadvantages and limitations of known solutions.

This object is achieved with a method for producing a construction component for a vehicle according to claim 1 or 4, with a construction component for a vehicle according to claim 8 and with a vehicle having a construction component according to claim 15. The dependent claims relate to advantageous developments of the invention.

According to a first aspect, in a method of producing a construction component for a vehicle having a composite structure, particularly a hollow cell structure, wherein the composite structure comprises at least one receptacle, this object is achieved in that the method includes a step of weaving an electrochemical cell, particularly a flat electrochemical cell, into the at least one receptacle of the construction component, or a step of weaving a plurality of electrochemical cells, particularly a plurality of flat electrochemical cells, into the at least one receptacle of the construction component. An advantage of this method consists in that portions of the volume of the structural components can be used for accommodating the electrochemical cells. These volumes in the vehicle, such as the engine, boot or passenger compartments, are thus made available for other purposes. In particular, the space set aside for the batteries inside the vehicle, or on the roof, or in a trailer can be reduced or even eliminated entirely. The space inside the construction components, which has hitherto been unused, may thus be put to use. Another advantage of this method consists in that the weight of the batteries can be spread advantageously throughout the vehicle structure. A further advantage of this method is that as a consequence of the weaving step the energy input into the electrochemical cells and the cell bodies during production can be reduced, thereby avoiding damage thereto, and thus also increasing the safety of the manufacturing process. A further advantage consists in that maintenance may be simplified because of the higher degree of integration of the electrochemical cells in the construction component.

In this context, an electrochemical cell is understood to be an electrochemical energy storage device, that is to say a device that is able to store energy in chemical form, release energy to a consumer in electrical form, and preferably also take up energy in electrical form from a charging device. Important examples of such electrochemical energy storage devices are galvanic or fuel cells.

In this context, a flat electrochemical cell is understood to be an electrochemical cell of which the outer shape is characterized by two substantially parallel surfaces, and the vertical distance between which is smaller than the average length of the cell, measured parallel to said surfaces. The electrochemically active components of the cell are arranged between these surfaces, often enclosed in packaging or a cell housing. Such cells are commonly surrounded by a multilayer packaging film with a sealing seam on the edges of the cell packaging that is formed by a permanent joining or closure of the packaging film in the area of the sealing seam. Such cells are often referred to as pouch cells or coffee bag cells.

In this context, a construction component is understood to mean any bearing or cladding unit on the bodywork of the vehicle. For example, it may be a frame component or bodywork component or a bearing body part of a self-supporting body. Particularly preferably, the construction component has a flat structure, and in particular forms a wing, a floor, a boot lid or bonnet, a door or a roof of the vehicle. However, it is also conceivable for the construction component to be a frame, a sill or the like.

The construction component may be produced as a spunlaid non-woven and/or a continuous filament woven mat. A mat is preferably woven in the form of the construction component. An outer mat and an inner mat may be woven or laid or spun in the form of the construction component. The mats are preferably impregnated with resin and cured before they electrochemical cell is woven into them.

In a preferred embodiment the construction component comprises a belt material, which is preferably elastic and into which the electrochemical cells can be woven. An advantage of this embodiment is that the electrochemical cells can be protected particularly well against vibration.

In a particularly preferred embodiment, the electrochemical cells can be woven into the belt material in such manner that they can be taken out of the construction component if necessary, after an accident, for example. Thus, the electrochemical cells may have been woven into the construction component in a manner that allows them to be taken out again.

In this context, weaving an electrochemical cell into the receptacle of the construction component is understood to mean introducing the electrochemical cell into the receptacle in such manner that the electrochemical cell can be retained, by belt materials for example. In this context, according to a further embodiment weaving an electrochemical cell in may also be understood to mean introducing the electrochemical cell into a pocket in the construction component. According to a further embodiment, it is also possible for the electrochemical cell to be inserted between an outer mat and one inner mat of the construction component, and the outer mat and the inner mat are bonded together subsequently.

Particularly preferably, the thickness of the electrochemical cells is adapted to the thickness of the construction component, so that the volume of the construction component can be better utilized. The electrochemical cells may also be bent inwards to follow the geometry of the construction component.

The electrochemical cells may also comprise a stretchable multilayer film as an outer covering to absorb gases that are formed.

The electrochemical cells may also be semi-flexible or pliable and may be at least partly supported by the construction component, in order to be more readily adaptable to the geometry of the construction component.

In addition, the electrochemical cells may be constructed as prismatic cells such as flat cell frames, pouch cells or coffee bag cells, or as or plate cells with a relatively large surface area. The connectors and contacts may be arranged beside or on the sides of the electrochemical cells. An advantage of this variation is that the connecting parts thus do not add to the thickness, and the thickness of the construction components may be better utilized to accommodate the electrochemical cells. The electrochemical cells may be adapted in size and shape, particularly in terms of surface area and cross-sectional thickness, to the space available inside the construction component.

As it has proven advantageous if during the process of weaving in a plurality of electrochemical cells this step in carried out in such manner that the number of electrochemical cells in the at least one receptacle of the construction component forms an electrically connected assembly, which in turn forms a power supply unit for electrical and/or electronic/or control engineering purposes.

The method may further comprise at least one of the following steps: a step of introducing a safety apparatus into the construction component that is designed to isolate the power supply unit from an energy supply system of the vehicle when a predetermined condition occurs, or a step of introducing a control apparatus into the construction component that is designed to control the electrochemical cells in the construction component. The safety apparatus may comprise for example a PTC resistor or a current interruption unit.

According to a second aspect, in a method for producing a construction component for a vehicle having a composite structure, in particular a hollow cell structure, wherein the composite structure has at least one receptacle, this object is solved in that the method includes a step of weaving a cell body of an electrochemical cell into the at least one receptacle of the construction component or weaving a number of cell bodies of electrochemical cells into the at least one receptacle of the construction component.

It has proven advantageous if during this process weaving in a plurality of cell bodies of the electrochemical cells is carried out in such manner that the number of cell bodies of the electrochemical cells in the at least one receptacle of the construction component forms an electrically connected assembly, which in turn forms a power supply unit for electrical and/or electronic/or control engineering purposes.

It has proven particularly advantageous if in this method the cell body introduced into the receptacle of the construction component comprises active electrodes of the electrochemical cells, and if the method includes a step of filling the cell body with an electrolyte in the receptacle and a step of using the construction component as a holder and/or as an insert for subsequent processing steps in cell production until the final processing of the electrochemical cells.

The method preferably comprises at least one of the following steps: a step of introducing a safety apparatus into the construction component that is designed to isolate the power supply unit from an energy supply system of the vehicle when a predetermined condition occurs, or a step of introducing a control apparatus into the construction component, which is designed to control the electrochemical cells in the construction component.

According the further aspect, concerning a construction component for a vehicle having a composite structure, in particular a hollow cell structure, wherein the composite structure comprises at least one receptacle, the object is solved in that at least one electrochemical component from a group of components has been woven into the at least one receptacle, said group of components comprising: an electrochemical cell, a cell body of an electrochemical cell, a plurality of electrochemical cells or a plurality of cell bodies of electrochemical cells.

Regarding the construction component, it is preferred if a number of electrochemical cells and/or a number of cell bodies of electrochemical cells are connected electrically in the construction component in an arrangement in such manner that the arrangement forms a power supply unit that forms a power supply unit for electrical and/or electronic/or control engineering purposes. In particular, this power supply unit may have predetermined electrical properties, such as voltage and charging capacity. The construction component with its electrochemical cells may thus form a replaceable module so that after an accident, for example, a damaged module can be replaced without affecting other modules from an electrical point of view.

Regarding the construction component, it is particularly preferred if the power supply unit is designed to supply a uniquely assigned consumer, preferably an electric motor, in particular a wheel hub motor. In this embodiment, the electrochemical cells of a construction component that are connected together to form a power supply unit are allocated to a specific consumer. For example, a right front wing, a front passenger door and a front boot or engine compartment lid form three battery modules that can be assigned to a hub motor of the right front wheel. Similarly, a left front wing, a driver's door and a bottom pan form three battery modules that can be assigned to a hub motor of the left front wheel. In the same way, a right rear wing, a right rear passenger door, and a boot or engine compartment lid form three battery modules that can be assigned to a hub motor of the right rear wheel. Further, a left rear wing, a left rear passenger door and a vehicle roof form three battery modules that may be assigned to a hub motor of the left rear wheel. Finally, walls between the luggage or engine compartments, frame parts, bumpers and the like form battery modules that are assigned to other consumers such as lighting, heating/cooling, controlling, power steering, navigation, audio/video, etc.. This also makes it possible to increase operating reliability in the event of failure or partial failure of such a module or a similar incident.

In addition, the construction component may comprise a safety apparatus that is designed to isolate the power supply unit from an energy supply system of the vehicle when a predetermined condition occurs. The predetermined condition may be for example external damage and/or an electrical malfunction. Thus, for example, a damaged module may be removed from the electrical assembly after an accident without interfering with the other modules. The other modules may optionally take over the tasks of the failed module. Corresponding sensors such as temperature sensors, voltmeters, or extensometers are preferably provided in order to decide whether the predetermined conditions are present.

It has proven to be advantageous if a control apparatus for controlling the electrochemical cells is located in the construction component.

In addition, a central control unit may be provided, configured and programmed to perform charge balancing between the battery modules as needed and on the basis of predefined or predefinable criteria. Thus for example in darkness, particularly at night, on longer journeys using lights, in particular main beam and/or foglamps, the charge from other battery modules may be routed to the battery modules assigned to the lights if the charge state of the battery modules assigned to the lights falls below a predefined threshold. In the same way, for example, on journeys in cold weather the charge from other battery modules may be routed to the battery modules assigned to the heater if the charge state of the battery module assigned to the heater falls below a predefined threshold. Similar criteria may be set up for other battery modules.

The voltage of a module may be limited or is limited. The voltage of a module is preferably between 48 and 150 V, in a lightweight electric vehicle between 7.2 and 36 V. In this context, the voltage of a module is a sum of the voltages of the individual cells, which for lithium systems may be for example, 2.7 V or 3.6 V up to 5 V. The voltage of a module is particularly preferably designed to meet the need of the major consumers, particularly of a wheel hub motor.

The electrochemical cells may be constructed as binary cells. Battery cells that comprise at least two electrode stacks in a common housing are called binary cells. The two electrode stacks preferably differ from one another, in particular they are designed with different electrical properties. With binary cells it is possible to obtain desired electrical properties with particularly low space requirement. In particular, it is possible to achieve higher cell voltages than with individual cells. With binary cells it is possible to achieve cell voltages up to about 12 V.

Moreover, the electrochemical cells may be constructed so that they conform to the shape of the construction component. In particular, the electrochemical cells may be pliable and able to lie flush with the entire surface of the construction component. An advantage of this variation consists in that the construction component is able to support the electrochemical cells, and to some degree severs as a bearing surface for the cells.

Moreover, the housing of the electrochemical cells may be constructed from a stretchable foil. In this way, changes in the cell volume caused by gas release in the interior thereof can be compensated. If additional space is also built into the construction component for expansion, damage can be avoided. Operating reliability may be further increased thereby. The flexibility of the foil may be provided in sections. The flexibility of the film may also be associated with a particularly thin foil. Since the cells are supported by the construction component, the foil may be thinner than that of conventional coffee bag cells or the like. A degassing chamber is formed, but this is not able to trigger a cascade effect with the other cells, which is a particular consideration even when binary cells are used. The composite material may prevent spark formation and the uncontrolled escape of materials or hot gas from a damaged battery even in an accident by trapping such substances.

The electrochemical cells woven into the construction component preferably use the construction component as a heat sink.

The body parts may also be manufactured conventionally rather than as a lightweight structure. For example, a body part may comprise an outer panel, an inner cladding and a plurality of stiffeners in the form of ribs or stringers.

In this case, the electrochemical cells may be installed or attached in the spaces between the stiffening members.

Electrochemical cells may also be used in which the contacts or terminals are arranged on one or both flat sides of the cell. In this case, the contacts may be contacted via ribbon cables or a strip contact. In this way, the contacting arrangement also helps to limit additional thickness.

The above considerations are also not limited to electrically powered vehicles; they can also be applied anywhere where electrical energy storage devices with a certain space requirement are used and construction components that can be configured as described in the preceding are available. Examples of such include systems for electricity generation, distribution and supply systems, where, for example, storage and buffer batteries can be accommodated in appropriately designed walls, floors, ceilings, platforms and the like.

Besides batteries or accumulators, it is also conceivable to construct capacitors, supercapacitors, fuel cells and the like as cells for storing electrical energy.

According to another aspect, the object is achieved in a vehicle with an electric drive by implementation of the construction components described in the preceding.

The vehicle comprises lightweight construction components. For the purposes of the invention, construction components may be bearing structure parts, non-bearing cladding parts Or self-supporting bodywork parts. In particular, construction components may be doors, engine compartment lids, boot lids, roofs, wings, bulkheads, frame members, sills. The lightweight design may particularly be achieved with a honeycomb or hollow cell structure, which imparts stability to a volume that is defined by an outer skin.

The features of the embodiments described and others of the invention may be advantageously combined with each other in such manner that a person skilled in the art would discern yet further embodiments that are cannot be described exhaustively and comprehensively here.

In the following the invention will be described greater detail with reference to preferred embodiments and with the aid of the drawing. In the drawing:

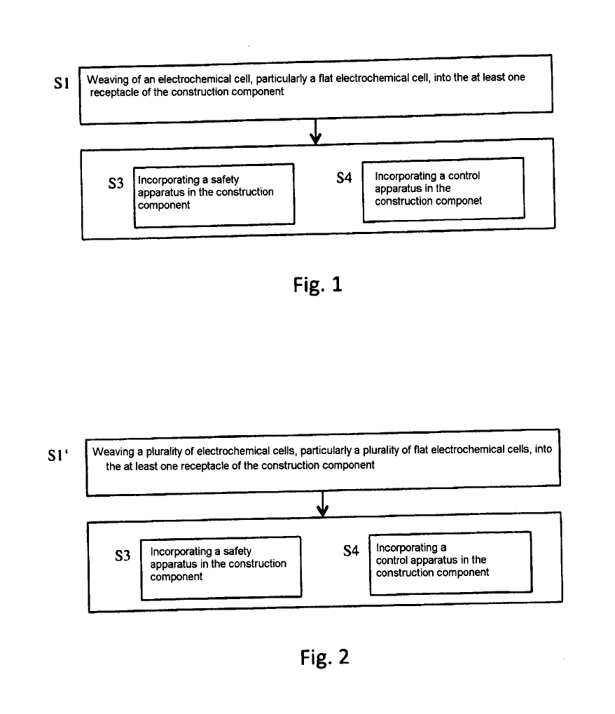

FIG. 1 is a flowchart of a method for producing a construction component according to a first embodiment,

FIG. 2 is a flowchart of a method for producing a construction component according to a second embodiment,

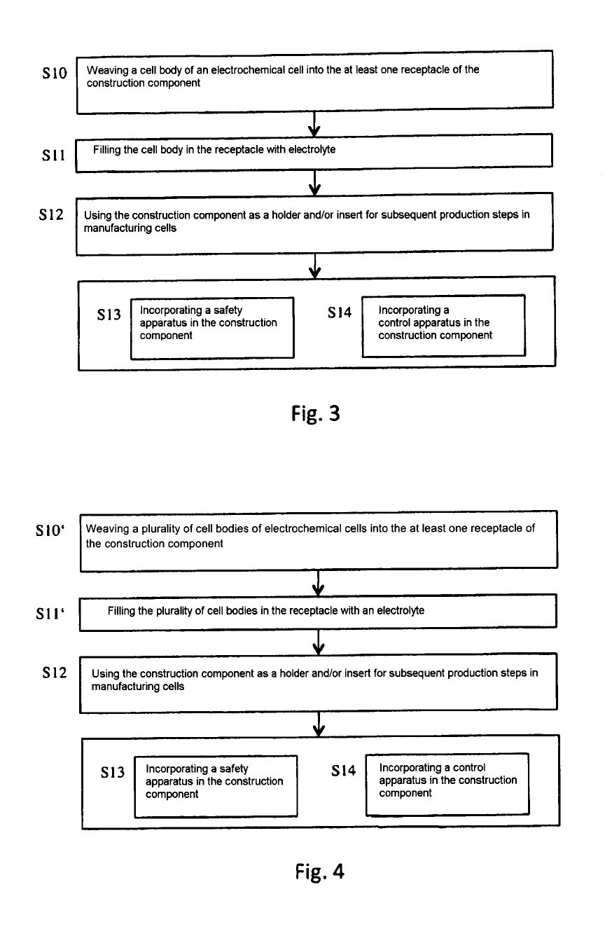

FIG. 3 is a flowchart of a method for producing a construction component according to a third embodiment, and

FIG. 4 is a flowchart of a method for producing a construction component according to a fourth embodiment.

FIG. 1 is a flowchart of a method according to a first embodiment for producing a construction component for a vehicle having a composite structure, particularly a hollow cell structure, wherein the composite structure comprises at least one receptacle. In a step S1, an electrochemical cell, preferably a flat electrochemical cell, is woven into the at least one receptacle of the structural component. In a step S3, a safety apparatus that is configured to isolate the electrochemical cell from a power supply system of the vehicle upon the occurrence of a predetermined condition may be incorporated in the construction component. Additionally, a control apparatus for controlling the electrochemical cell may be incorporated in the construction component in a step S4.

FIG. 2 is a flowchart of a method according to a second embodiment for producing a construction component for a vehicle having a composite structure, particularly a hollow cell structure, wherein the composite structure comprises at least one receptacle. In step S1′, a plurality of electrochemical cells, preferably a plurality of flat electrochemical cells, is woven into the at least one receptacle of the construction component. Step S1′ of weaving in a plurality of electrochemical cells may be carried out in such a manner that the number of electrochemical cells in the at least one receptacle of the construction component forms an electrically connected arrangement that in turn forms a power supply unit for electrical and/or electronic and/or control purposes.

In a step S3, a safety apparatus that is configured to isolate the electrochemical cell from a power supply system of the vehicle upon the occurrence of a predetermined condition may be incorporated in the construction component. Additionally, a control apparatus for controlling the electrochemical cell may be incorporated in the construction component in a step S4.

FIG. 3 is a flowchart of a method according to a third embodiment for producing a construction component for a vehicle having a composite structure, particularly a hollow cell structure, wherein the composite structure comprises at least one receptacle. In a step S10, a cell body of an electrochemical cell is woven into the at least one receptacle of the construction component. In a step S11, the cell body in the receptacle is filled with an electrolyte, and in a step S12 the construction component may be used as a holder and/or an insert for subsequent manufacturing steps in cell production until the completion of the electrochemical cell.

In a step S13, a safety apparatus that is configured to isolate the electrochemical cell from a power supply system of the vehicle upon the occurrence of a predetermined condition may be incorporated in the construction component. Additionally, a control apparatus for controlling the electrochemical cell may be incorporated in the construction component in a step S14.

FIG. 4 is a flowchart of a method according to a fourth embodiment for producing a construction component for a vehicle having a composite structure, particularly a hollow cell structure, wherein the composite structure comprises at least one receptacle. In a step S10′, a plurality of cell bodies of electrochemical cells are woven into the at least one receptacle of the construction component. Step S10′ of weaving in a plurality of cell bodies of electrochemical cells may be carried out in such a manner that the plurality of electrochemical cells in the at least one receptacle of the construction component forms an electrically connected arrangement that in turn forms a power supply unit for electrical and/or electronic and/or control purposes.

In a step S11′, the plurality of cell bodies in the receptacle is filled with an electrolyte, and in a step S12 the construction component is used as a holder and/or an insert for subsequent manufacturing steps in cell production until the final processing of the electrochemical cells.

In a step S13, a safety apparatus that is configured to isolate the electrochemical cell from a power supply system of the vehicle upon the occurrence of a predetermined condition may be incorporated in the construction component. Additionally, a control apparatus for controlling the electrochemical cell may be incorporated in the construction component in a step S14.

### LIST OF REFERENCE SIGNS

S1 Weaving in of an electrochemical cell

S1′ Weaving in of a plurality of electrochemical cells

S3 Incorporation of a safety apparatus in the construction component

S4 Incorporation of a control apparatus in the construction component

S10 Weaving in of a cell body of an electrochemical cell

S10′ Weaving in of a plurality of cell bodies of an electrochemical cell

S11 Filling the cell body in the receptacle with an electrolyte

S11′ Filling the plurality of cell bodies in the receptacle with an electrolyte

S12 Using the construction component as a holder and/or insert for subsequent production steps in cell manufacture

S13 Incorporating a safety apparatus in the construction component

S14 Incorporating a control apparatus in the construction component

1. A method for producing a construction component for a vehicle having a composite structure, particularly a hollow cell structure, wherein the composite structure comprises at least one receptacle, the method comprising:
weaving an electrochemical cell into the at least one receptacle of the construction component or weaving a plurality of electrochemical cells into the at least one receptacle of the construction component.

2. The method according to claim 1, wherein weaving a plurality of electrochemical cells is performed in such a manner that the plurality of electrochemical cells in the at least one receptacle of the construction component forms an electrically connected arrangement that forms a power supply unit for at least one of electrical, electronic, or control purposes.

3. The method according to claim 2, further comprising:
incorporating a safety apparatus into the construction component that is configured to isolate the power supply unit from an energy supply system of the vehicle when a predetermined condition occurs, or
incorporating a control apparatus into the construction component that is configured to control the electrochemical cells in the construction component.

4. A method for producing a construction component for a vehicle having a composite structure, particularly a hollow cells structure, wherein the composite structure has at least one receptacle, the method comprising:
weaving a cell body of an electrochemical cell into the at least one receptacle of the construction component, or weaving a plurality of cell bodies of electrochemical cells into the at least one receptacle of the construction component.

5. The method according to claim 3, wherein the weaving in of a plurality of the cell bodies of the electrochemical cells is carried out in such manner that the plurality of the cell bodies of the electrochemical cells forms a power supply unit for at least one of electrical, electronic or control purposes.

6. The method according to claim 4, wherein the cell body introduced into the receptacle of the construction component in the weaving in of a plurality of the cell bodies comprises active electrodes of the electrochemical cells, and the method further comprises:
filling the cell body in the receptacle with an electrolyte, and
using the construction component as at least one of a holder or insert for subsequent processing steps in cell production until a final processing of the electrochemical cells.

7. The method according to claim 4, characterised in that the method comprises at least one of the following steps:
(S13) Incorporating a safety apparatus in the construction component, that is configured to isolate the power supply unit from an energy supply system of the vehicle when a predetermined condition occurs, or
(S14) Incorporating a control apparatus in the construction component, which is configured to control the electrochemical cells in the construction component.

8. A construction component for a vehicle having a composite structure, wherein the composite structure comprises at least one receptacle, and at least one electrochemical component including:
an electrochemical cell,
a cell body of an electrochemical cell,
a plurality of electrochemical cells, or
a plurality of cell bodies of electrochemical cells.

9. The construction component according to claim 8, wherein a plurality of electrochemical cells or a plurality of cell bodies of electrochemical cells are connected electrically in the construction component to form an arrangement in such manner that the arrangement forms a power supply unit for at least one of an electrical, electronic, or control purposes.

10. The construction component according to claim 9, wherein the power supply unit is configured to supply a uniquely assigned consumer.

11. The construction component according to claim 9, further comprising a safety apparatus configured to isolate the power supply unit from an energy supply system of the vehicle when a predetermined condition is present.

12. The construction component according to claim 9, characterised in that a control apparatus for controlling the electrochemical cells is arranged in the Construction component.

13. The construction component according to claim 8, wherein the construction component comprises a flat component.

14. The construction component according to claim 13, wherein the flat component includes:
wing,
floor,
boot lid,
engine compartment lid,
door,
roof,
frame or
sill.

15. A vehicle equipped with an electrical drive, wherein the electrical drive includes at least one construction component according to claim 8.
